(19) United States
(12) Patent Application Publication
(10) Pub. No.: US 2026/0101416 A1
(43) Pub. Date: Apr. 9, 2026

(54) GRAPHITIZATION TROUGH SYSTEM

(71) Applicant: GRAFTECH INTERNATIONAL HOLDINGS INC., Brooklyn Heights, OH (US)

(72) Inventors: William Eric SLYE, Cuyahoga Falls, OH (US); Nathanael Henderson MAY, Brecksville, OH (US); Ryan Michael PAUL, Willoughby, OH (US); Mark SEGGER, Ontario (CA)

(21) Appl. No.: 19/353,961

(22) Filed: Oct. 9, 2025

Related U.S. Application Data
(60) Provisional application No. 63/705,097, filed on Oct. 9, 2024.

(51) Int. Cl. H05B 3/06; C01B 32/205; H05B 3/14; H05B 3/28

(52) U.S. Cl. CPC H05B 3/06; H05B 3/145; H05B 3/28; C01B 32/205

(57) ABSTRACT

A system for graphitization of carbon powder, the system including a graphitization container having a body made of a carbonaceous material. The body has a cavity extending in a longitudinal direction, and the body has an opening in communication with the cavity. The container includes a heating element made of a carbonaceous material, wherein the heating element is positioned in the cavity such that the heating element extends in the longitudinal direction. The container includes a lid configured to removably cover the opening. The system is configured such that when the lid is removed, the opening provides access to the cavity in a direction perpendicular to the longitudinal direction for at least one of loading or unloading of a payload material into or out of the cavity.

This application claims priority to U.S. provisional patent application Ser. No. 63/705,097 filed on Oct. 9, 2024, the entire contents of which are hereby incorporated by reference.

The present disclosure relates to a trough for graphitization of carbon materials.

### BACKGROUND

Graphitization of carbon materials typically involves heating a starting or payload material, such as amorphous carbon, to a predetermined temperature for a predetermined period of time. During the graphitization process the carbon atoms of the payload material rearrange, resulting in crystal growth and a decrease in interlayer spacing to produce graphite. In some cases the payload material is heated to temperatures of about 2,000° C.-3,000° C., or more, to provide sufficient graphitization.

In an Acheson-type graphitization furnace for graphitizing carbon powders, the payload material is first positioned in containers. The containers are then positioned in an electrically conductive packing material, such as loose coke particles. An electric current is passed through the conductive packing material to heat the containers. The containers and payload material are thereby heated by heat radiating from the packing material, in an outside-in manner. However, Acheson graphitization furnaces require long cycle times and high energy usage.

In a longitudinal graphitization furnace or process (also known as a lengthwise graphitization furnace/process), the payload powder material is loaded into a container. Electric current is then directed through the container and/or payload material to heat the payload material to the desired temperature for the desired period of time. However, since the payload material is not particularly electrically conductive, it can be difficult and time consuming to heat the payload material to the desired temperature.

### SUMMARY

In one embodiment, the invention is a system for graphitization of carbon powder, the system including a graphitization container having a body made of a carbonaceous material. The body has a cavity extending in a longitudinal direction, and also has an opening in communication with the cavity. The container includes a heating element made of a carbonaceous material, wherein the heating element is positioned in the cavity such that the heating element extends in the longitudinal direction. The container further includes a lid configured to removably cover the opening. The system is configured such that when the lid is removed, the opening provides access to the cavity in a direction perpendicular to the longitudinal direction for at least one of loading or unloading of a payload material into or out of the cavity.

### BRIEF DESCRIPTION OF THE DRAWINGS

FIG. 1 is a perspective view of one embodiment of a graphitization container;

FIG. 2 is an exploded view of the container of FIG. 1;

FIG. 3 shows three containers of FIG. 1 without lids, stacked end-to-end, and shown in conjunction with a pair of end caps;

FIG. 4 shows the stacked containers and end caps of FIG. 3, with lids, in conjunction with a containment device;

FIG. 5 shows the stacked containers and end caps of FIG. 4, positioned in the containment device;

FIG. 6 is a side cross section taken along line 6-6 of FIG. 5, with the lid of the container removed;

FIG. 7 shows the system of FIG. 6 with a payload material positioned in the container;

FIG. 8 shows the system of FIG. 7, with the lid positioned on the container and with the containment device filled with packing material;

FIG. 9 is a perspective view of the system of FIG. 8;

FIG. 10 is a cross section of the system, taken along line 10-10 of FIG. 9;

FIG. 11 is a perspective view of two containment devices, positioned adjacent to each other and fluidly connected via a heat transfer system, with part of the system cut away;

FIG. 11A is a detail view of a portion of the system of FIG. 11; and

FIG. 12 is a perspective view of two containment devices, positioned adjacent to each other and fluidly connected via a different heat transfer system.

### DETAILED DESCRIPTION

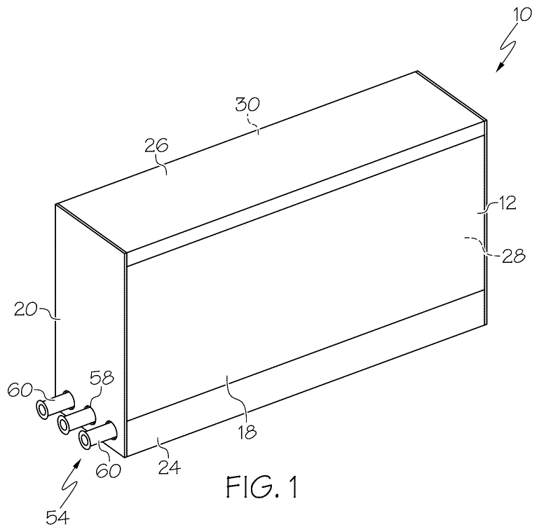

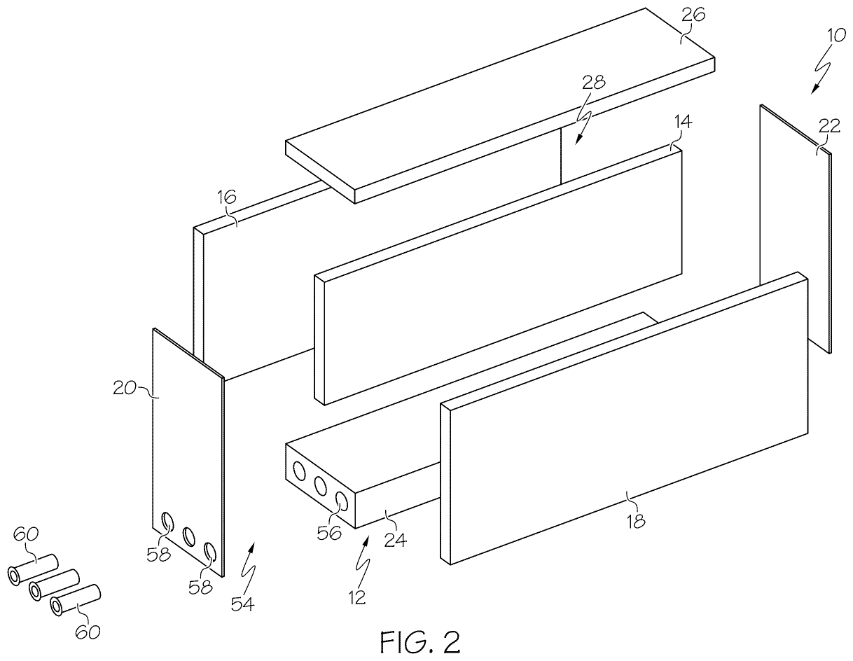

With reference to FIGS. 1 and 2, a graphitization container 10 is shown having a body 12 that can include/have a heating element 14 positioned therein. The body 12 can be generally rectangular prism in one case, having a pair of opposed, parallel side walls 16, 18, a pair of opposed, parallel end walls 20, 22, a bottom wall 24 and an upper, opposed lid 26 that is parallel with the bottom wall 24 when positioned as shown. The side walls 16, 18, end walls 20, 22 and/or bottom wall 24 and/or lid 26 together define a continuous inner cavity 28 that extends in a longitudinal direction (which can be in one case the direction of greatest length of the container 10/body 12/cavity 28/heating element 14).

The side walls 16, 18, end walls 20, 22 and bottom wall 24 can be removably coupled together, as shown in FIG. 1, to provide the container 10/cavity 28. The side walls 16, 18, end walls 20, 22 and bottom wall 24 can be removably coupled by any of a wide variety of mechanisms or means, such as interlocking shapes, fasteners, attachment devices or the like.

The side walls 16, 18, end walls 20, 22, and bottom wall 24 can be coupled together with sufficient strength to retain the rectangular prism shape shown in FIG. 1 without any external supports, and/or with sufficient strength to retain a payload material 44 therein without any external supports, as will be described in greater detail below. In one embodiment the side walls 16, 18, end walls 20, 22 and bottom wall 24 are not removably coupled by any threaded coupling between those components, and the lid 26 is not threadably configured to be threadably coupled to the remainder of the body 12. In other words, in one case one, more, or all of the side walls 16, 18, end walls 20, 22, bottom wall 24 or lid 26 lack threads integrally formed thereon configured to directly threadably engage and couple those components together. One or each of the side walls 16, 18, end walls 20, 22, bottom wall 24 and/or lid 26 can be a single monolithic seamless component, or alternatively can be made of two or more subcomponents joined together.

The container 10/body 12 can also have an opening 30 at its upper end that is in communication with, and/or provides access to, the cavity 28. The lid 26 can be configured to be coupled to and/or supported by the side walls 16, 18 and end walls 20, 22 when positioned in place. The lid 26 thereby removably covers the opening 30 and/or seals the cavity 28.

The container 10/body 12 can be relatively large and have a length of at least about ten feet in one case, or at least about twenty feet in another case, a width of at least about three feet in one case, or at least about five feet in another case, and height of at least about three feet in one case, or at least about five feet in another case. The cavity 28 can have a volume of at least about 100 cubic feet in one case, or at least about 250 cubic feet in one case, or at least about 500 cubic feet in yet another case. However the container 10/body 12 and cavity 28 can have other sizes, shapes or profiles beyond those shown herein, such as for example being significantly larger, and/or have shapes other than rectangular in vertical and/or horizontal cross section, such as generally circular, oval, square, octagonal or other shapes.

The heating element 14 can be a vertically-oriented rectangular slab/rectangular prism that is oriented parallel to the side walls 16, 18, but can have other shapes or profiles, as desired. In one case, the heating element 14 has a length, extending in the longest direction of the heating element 14, that is oriented along the horizontal direction. In one case the heating element 14 is in direct physical and/or electrical contact with the bottom wall 24, along an entire length of or substantially the entire length of (e.g. in one case, accommodating for the thickness of the end walls 20, 22) the heating element 14 and/or bottom wall 24 and/or cavity 28 in one case.

The heating element 14 can be centered in the cavity 28 and thus be equally spaced from the side walls 16, 18. The heating element 14 can have the same length as the side walls 16, 18, or substantially the same length as the side walls 16, 18 (e.g. allowing or accommodating for the thickness of the end walls 20, 22, in one case). The heating element 14 can be in direct physical and/or electrical contact with the end walls 20, 22, along an entire height of the heating element 14 (or substantially entire height, allowing or accounting for the thickness of the bottom wall 24 and/or lid 26 in one case) and/or an entire height (or substantially the entire height, in one case allowing or accounting for the thickness of the bottom wall 24 and/or lid 26) of the end walls 20, 22 in one case. When the lid 26 is in place and covers the cavity 28/opening 30, the lid 26 can be in direct physical and/or electrical contact with the heating element 14, along an entire length (or substantially entire length, accounting for a thickness of the end walls 20, 22 in one case) of the heating element 14 and/or lid 26 in one case.

In one case the heating element 14 is entirely positioned in/contained with the cavity 28, and does not extend beyond the cavity 28 and/or body 12 and/or end walls 20, 22 in the longitudinal direction (or any other direction). The heating element 14 can be relatively small, relative to the cavity 28, to ensure sufficient space for receipt of the powder/payload material 44 in the cavity 28. In one case the heating element 14 constitutes less than 40%, and in another case less than 20%, of the volume of the cavity 28, and in another case constitutes more than 1%, and in another case more than 5%, of the volume of the cavity 28 to provide sufficient heating.

The body 12 (including any one or more, or all, of the side walls 16, 18, end walls 20, 22, bottom wall 24, lid 26 and heating element 14) can be electrically conductive, and can made of the same or similar materials used to form graphite electrodes for electric arc furnaces.

Accordingly the body 12 (and subcomponents) can be a solid material and include carbon and/or be primarily made of carbon by weight and/or volume, and/or be a carbonaceous material, and/or be substantially or primarily (by weight and/or volume) made of a graphite such as a graphitized mixture of coke (for example needle coke), calcined petroleum coke, calcined anthracite, and can also include a binder, such as for example pitch, coal tar pitch or petroleum pitch, that is formed, baked, impregnated, graphitized and machined. In one case the body 12 (and subcomponents) is not refractory material or other inorganic material, and/or does not comprise by more than 10% by volume and/or weight, of refractory material or other inorganic materials. The body 12 (and subcomponents) may be relatively electrically conductive, and able to accommodate electrical currents densities in excess of 20 A/cm² in one case, or in excess of 30 or 35 A/cm² in another case, while retaining its shape and dimensional properties. The electrical resistivity of the material of the body 12 (and subcomponents) in one case is greater than about 2 micro-Ohm*meter, and in another case is less than about 20 micro-Ohm*meter.

The body 12 (and subcomponents) may be able to be heated to and withstand temperatures of at least about 2,000° C. in one case, or least about 2,800° C. in another case, or at least about 3,000° C. in another case, or at least about 3200° C. in yet another case, while retaining its shape and dimensional properties, and while remaining electrically conductive. U.S. Pat. No. 10,237,928, the entire contents of which are hereby incorporated by reference, discloses electrodes and methods for making such electrodes, which materials and methods can be used to make the body 12 and subcomponents (including any one or more, or all, of the side walls 16, 18, end walls 20, 22, bottom wall 24, lid 26 and heating element 14).

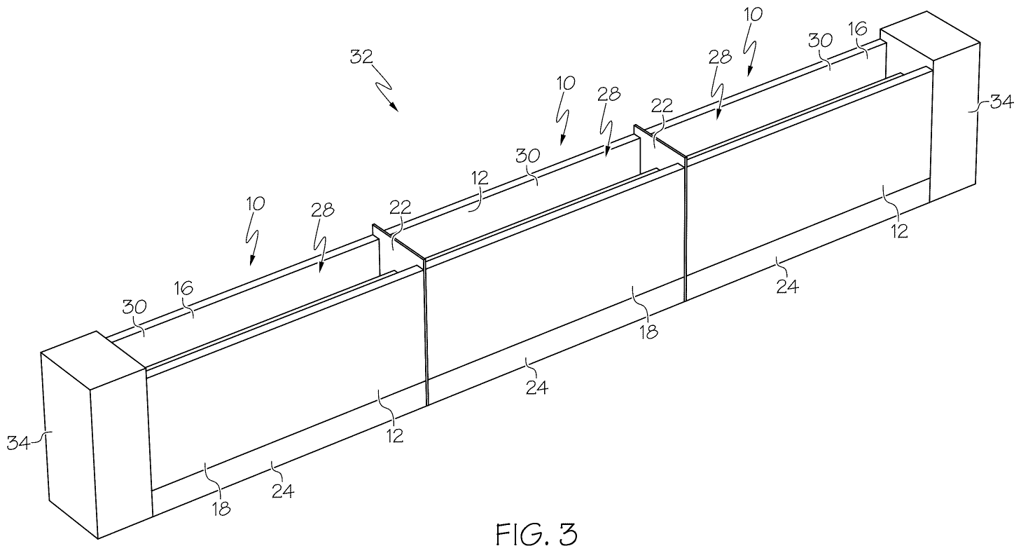

After the container 10 of FIGS. 1 and 2 is assembled, the container 10 can be used in the graphitization of a payload material 44, such as carbon powder, in a longitudinal graphitization process. In one case, multiple containers 10 (of the same type described above) can be assembled/provided, and placed end-to-end, such that the end wall 20 and/or end wall 22 of one container 10 is aligned with and positioned adjacent to, and in physical and/or electrical contact with, a corresponding end wall 20, 22 of another, or supplemental, container 10 to form a container column 32, as shown in FIG. 3.

In one case, each container 10 is positioned in direct contact with any adjacent container(s) 10 with no components positioned therebetween. In another case, a spacer (not shown), such as an electrically conductive, compressible spacer made of, for example flexible graphite, is positioned between two adjacent containers 10. The spacer(s) can be compressible to accommodate thermal expansion/contraction of the containers 10, and to accommodate any imprecise tolerances/fit between the containers 10. Because each container 10 is, in one case, in physical and/or electrical contact with the adjacent containers 10, electrical current passes through each of the containers 10. The column 32 can be made as long as desired but FIG. 3 shows the column 32 having three containers 10.

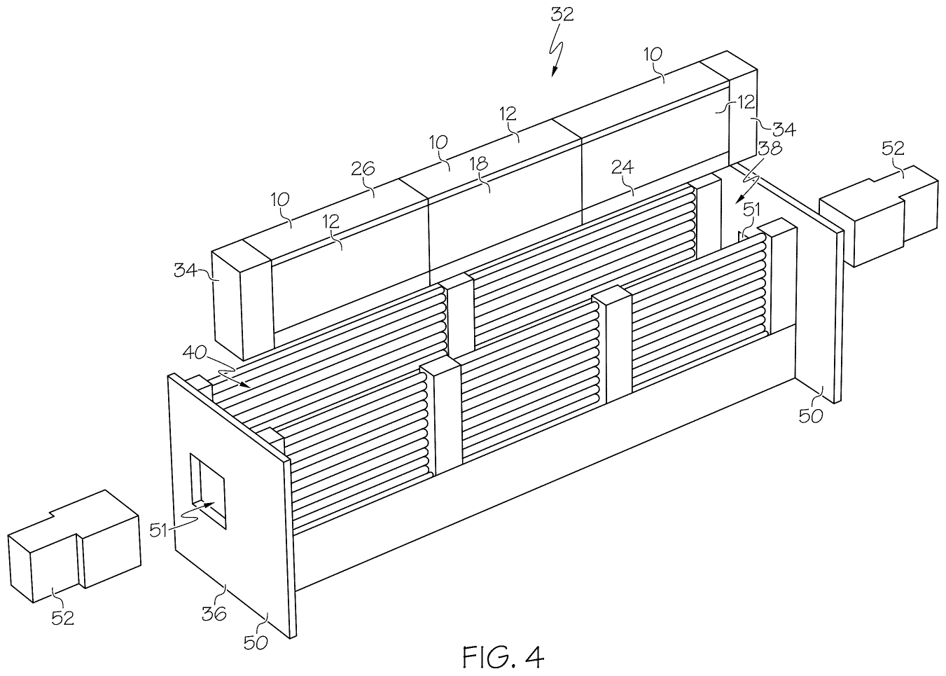

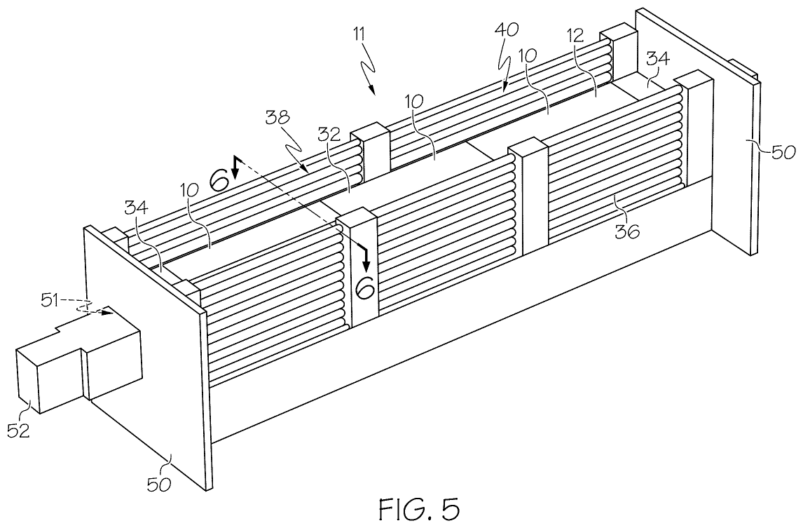

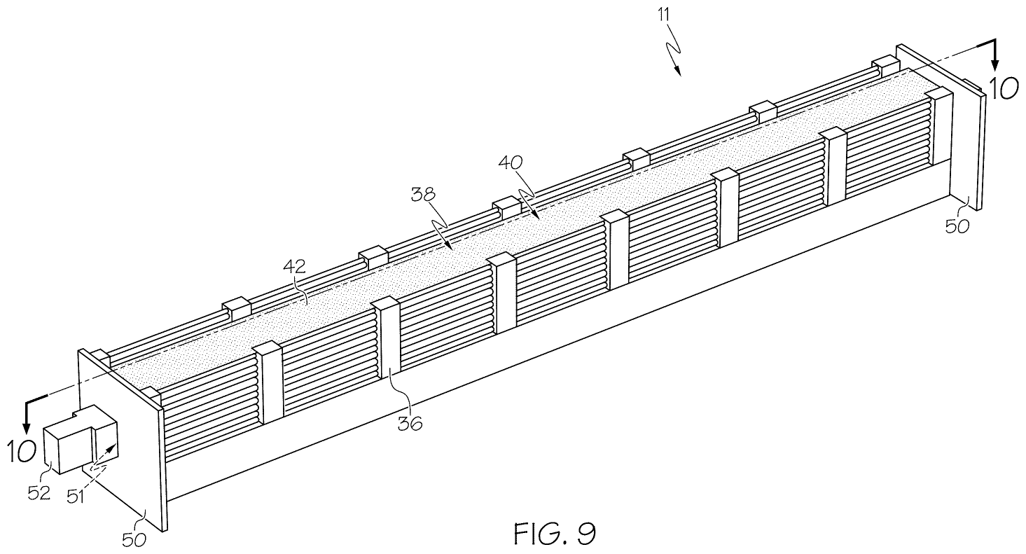

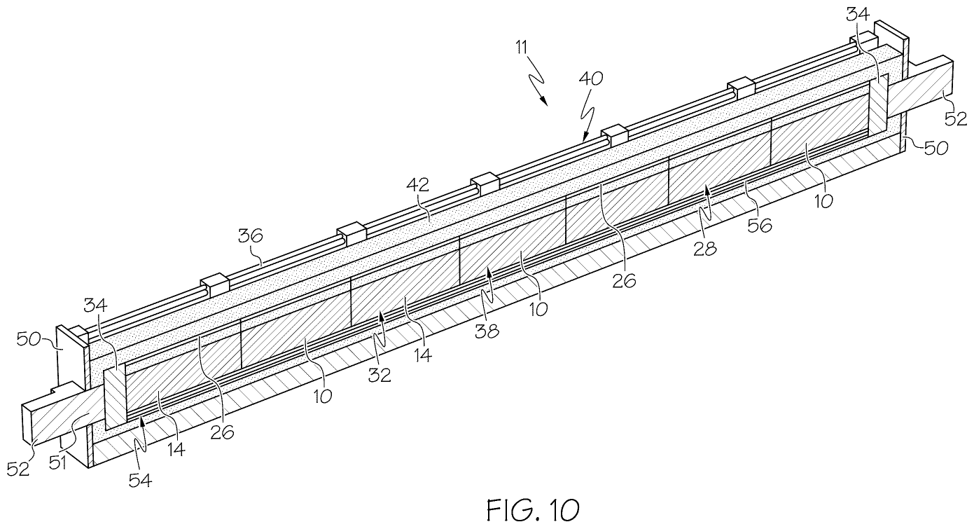

A pair of end caps 34 can be positioned on opposite ends of the container column 32. The end caps 34 can be relatively strong and rigid, and electrically conductive, and made of the same materials as those of the body 12 (and subcomponents) described above, and can accommodate and disperse compressive forces. The container column 32 can then be placed in compression, for example by pressing the container column 32 between the end caps 34, and then lifted as unit and placed in a containment device 36, such as a cradle as shown in FIGS. 4 and 5, to form a graphitization system 11. Alternatively, each container 10 can be individually lifted and placed in the containment device/cradle 36 to form the container column 32 in the containment device 36. The containers 10/container column 32 can, in one case, be oriented in a horizontal or generally horizontal orientation with regard to a gravitational frame of reference, as shown in FIGS. 4-12 (e.g. in one case, such that the longitudinal axis/longest dimension of the containers 10/container column 32/heating element 14 is horizontally aligned).

In the illustrated embodiment, the cradle 36 is shaped as a generally rectangular prism, with an open top, that is larger than the container column 32. The cradle 36 can have a cavity 38 for receiving the container(s) 10 therein, and an upper opening 40 through which the containers 10 can be passed into or out of the cradle cavity 38. The cradle 36 can be made of or include refractory material, metals, or other inorganic material, and in one case is not made of or does not include carbon or carbonaceous material (in one case does not comprise carbon or carbonaceous material greater than 10% by volume and/or weight).

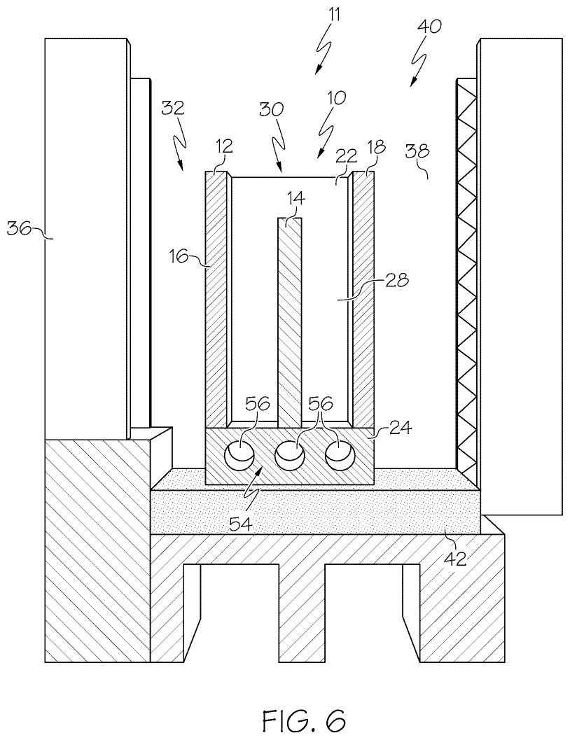

With reference to FIG. 6, prior to placing the container(s) 10 in the cradle 36, a bed of packing material 42 can be positioned at the bottom of the cradle 36, such that the containers 10/container column 32 are positioned on the bed of packing material 42. The packing material 42 can be loose material that provides thermal insulation and/or shielding from atmospheric oxygen for those components covered by the packing material 42. The packing material 42 can be carbonaceous media such as metallurgical coke, petroleum coke, carbon black and the like.

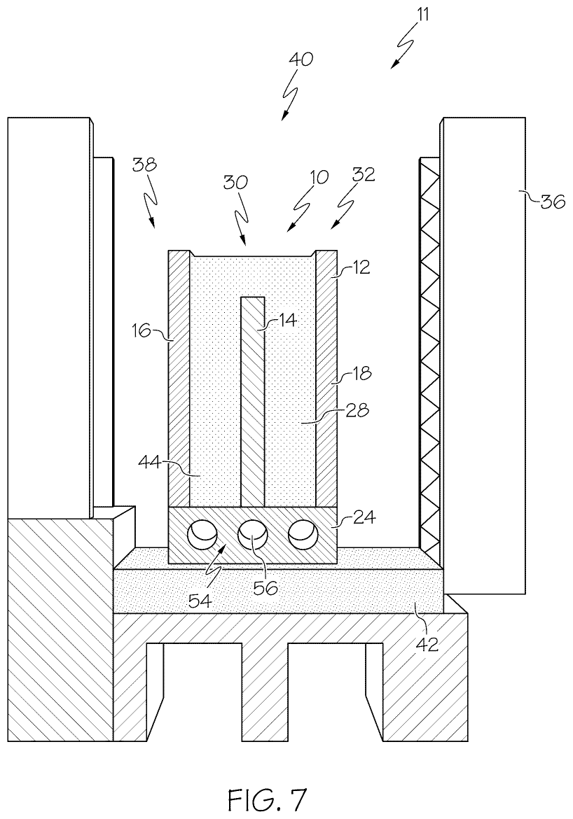

Continuing with FIG. 6, the lid 26 of each container 10, if present, can be removed, and each container 10 can then be filled with a starting payload material 44, as shown in FIG. 7. The payload material 44 can be a carbon powder material including carbon powders that, once graphitized, can be used as an active anode material in batteries, such as lithium-ion batteries.

The payload material 44, when taking the form of carbon, can be nearly any form of carbon material, and in one case is a particulate carbon material having an average and/or median particle size between about 1 micrometer and about 100 micrometers in one case, or at least about 1 micrometer in one case, and/or less than about 100 micrometers in one case, and/or less than about 1000 micrometers in another case and/or less than about 10,000 micrometers in yet another case.

In one case each container 10 is filled with payload material 44 such that each heating element 14 is substantially and/or entirely covered with/immersed within the payload material 44. The payload material 44 can be passed through the opening 30 to the cavity 28 by use of a crane, front loader, overhead clamshell bucket, etc. the in a direction generally perpendicular to longitudinal direction/central axis of the container 10. For example the crane, front loader, clamshell bucket can drop material in the vertical direction through the opening 30 into the cavity 28, and such loading can be in the generally vertical/generally perpendicular direction, accommodating for the natural spread of material as it fall under gravity.

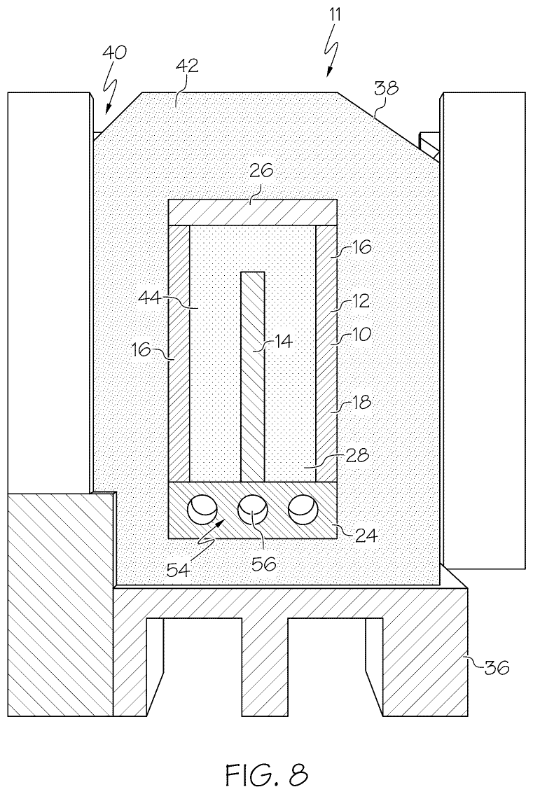

After the starting payload material 44 is positioned in the container(s) 10, a lid 26 is then placed on top of each of the filled containers 10. The cradle 36 is then filled or substantially filled with the packing material 42 as shown in FIG. 8, such that the containers 10 are at least partially, and in one case completely, covered by/surrounded by/immersed in the packing material 42. The packing material 42 thus can be positioned between the cradle 36 and the containers 10 on all six sides of the containers 10 in one case, or between the cradle 36 and the containers 10 on at least part of at least five sides of the containers 10 in another case (e.g. in one case, all sides except the lid 26).

Once the payload material 44 is loaded in each container 10 and the containers 10 are closed, and the packing material 42 is added, electrical current is passed through the containers 10 (including the heating elements 14), and to the extent possible, the payload material 44. As a practical matter however the current passing through the payload material 44, particularly at the beginning of the graphitization process, may be relatively low.

With reference to FIGS. 4, 5, 9 and 10, in some cases if desired the system 11 can include a pair of opposed pusher blocks 52 that extend through corresponding openings 51 in the end walls 50. The pusher blocks 52 place the container column 32 in compression to reduce voids between adjacent containers 10 (and/or reduce voids between or adjacent spacers, if utilized) to reduce electrical resistance. With reference to FIG. 4, in one case electrical contacts can be applied to the end walls 50 of the cradle 36, and/or the pusher blocks 52, and a voltage differential applied, to create the current flow.

When the current flows through the system 11, the container 10 (including the heating element 14) are thereby resistance heated due to the current passing therethrough. The resistance heating of the container 10 and heating element 14 thereby cause heat to transfer radially inwardly from the walls 16, 18, 20, 22, lid 26 and/or bottom wall 24 into the payload material 44, and also transfer radially outwardly from the heating element 14 into the payload material 44, thereby raising the temperature of, and graphitizing, the payload material 44. In this embodiment, the payload material 44 may remain generally stationary/in place during the graphitization process, and in particular the payload material 44 does not pass through the length of the container 10 during graphitization. The payload material 44 can be in direct contact with the container 10, which acts as a heating element, to effectively graphitize the payload material 44.

The containers 10 can be heated to achieve a predetermined temperature in the payload material 44 for a predetermined time. The payload material 44 may be desired to be heated at or to a target temperature of about least about 2,000° C. in one case, or at least about 2,800° C. in another case, or at least about 3,000° C. in another case, or at least about 3200° C. in yet another case, and the target temperature can be maintained for a hold time period of at least about 1 hour in one case, or at least about 3 hours in another case, or at least about 24 hours in yet another case. The target temperature can be maintained (for a hold time) for less than about 24 hours in one case, or less than about 6 hours in another case, or less than about 2 hours in another case, or less than about 0.5 hours in yet another case.

In one example, the starting payload material 44 is heated to a temperature exceeding 2900° C. for a minimum of 10 hours, and in another example the payload material 44 is heated to a temperature exceeding 3200° C. for between 0.5 and 4 hours. When the payload material 44 is desired to be used, after graphitization, as graphite anode powder (for example in a lithium-ion battery), the payload material 44 may be desired to be heated sufficiently to induce graphite crystallization, which leads to a low d-spacing between graphite layer planes. For example, in one case the d-spacing is desired to fall below 3.363 angstroms, while in another it is desired to fall below 3.360 angstroms. When the system 11 is used to graphitize carbon, the finished payload product can be graphite powder having a particle size distribution of D10 5-20 μm; D50 10-30 μm; D90 20-40 μm with a Dmax of 90μm, and average/median size of 10-30 μm.

In one case, the lossy (undesirable) resistances in the system 11 (for example resistances at junctions between walls 16, 18, 20, 22 and/or lid 26 and/or heating element 14 of the container 10, or between adjacent containers 10, or between container 10 and end caps 34, and the like), which necessarily excludes the resistance provided by the body 12 (including resistance heating provided by the heating element 14) and the payload material 44 (which are desired to provide relatively high resistance and/or desired to be heated), as an aggregate total, contribute less than 0.5% in one case, or less than 1% in another case of: 1) the total resistance of the system 11 in operation and/or 2) Joule heating of the system 11 in operation. Conversely, in one case the body 12 (including the heating element 14) provides at least 90% in one case, or at least 95% in another case, or at least about 97% in yet another case, of 1) the total resistance of the system 11 in operation and/or 2) Joule heating of the system 11 in operation. These parameters can apply in one case at the beginning of the graphitization process, and/or at the end of the graphitization process in another case, and/or any or all stages intermediate thereto.

As noted above, the payload material 44 can be relatively thermally and electrically insulating. Thus a limiting factor in determining how quickly the payload material 44 can be graphitized is the amount of time that it take the coolest part of the payload material 44 (e.g., typically the portion of the payload material 44 located furthest from a heat source) to achieve the desired temperature for the desired time. Thus the presence of the heating element 14, which can be located in the center of each container 10/payload material 44, significantly reduces processing time required to raise all of the payload material 44 to a sufficiently high temperature to graphitize the payload material 44. In one embodiment, and with reference to FIG. 8, the (vertical) distance between the heating element 14 and the lid 26 is about the same (within +/−5% in one case, or within +/−10% of another case) as the (horizontal) distance between the heating element 14 and the side walls 16, 18 to ensure relatively even heating of the payload material 44.

The container 10 can provide quick and easy access to the cavity 28 for loading/unloading the payload material 44. In particular, when the lid 26 is removed, the opening 30 provides full access to the cavity 28 in the vertically downward and/or radial direction, perpendicular to a central axis of the container 10/heating element 14, that extends in the longitudinal direction. In this manner the container 10 can remain in place, positioned in the cradle 36, and payload material 44 can be loaded (e.g. by use of a crane, front loader, overhead clamshell bucket, etc.) and/or unloaded (e.g. by use of a suction or vacuum device) while the container 10 remains in place in the cradle 36. In contrast, in many existing longitudinal graphitization furnaces, the container 10 (or container equivalent) must be removed from the cradle 36 for loading and/or unloading. The opening 30 provides access to the cavity 28 in a direction perpendicular to the longitudinal direction/central axis of the container 10 for loading and/or unloading of the payload material 44. The opening 30 can extend an entire length, or at least 80% in one case, or at least 90% in another case, of the length of the cavity 28 and/or of the length of the heating element 14 to provide access to the cavity 28 for loading and/or unloading.

Thus the containers 10 can be considered a semi-permanent part of the system 11. However if desired each container 10 can be removed from the cradle 36 for servicing, repair and/or replacement, or even for loading/unloading if desired. In addition, the containers 10 can be of a modular construction, such that the walls 16, 18, 20, 22, lid 26 and/or heating element 14 can be replaced as desired to extend the life of the container 10. The containers 10 also may not use threaded heating elements or connections to couple together any one and/or all of the components 14, 16, 18, 20, 22, 26 (e.g. those components may not carry threads thereon and/or may not be directly threadably connected or connectable to each other) which can lead to better electrical conductivity between connected component, and provide ease of manufacture and assembly. The lack of threaded connections can also enable the size of the cavity 28 to be increased, since the system 11 does not need to provide an additional (axial) length needed to accommodate such threaded connections, which thereby improves the volumetric processing capacity of the system 11.

With reference to FIGS. 6, 10, 11 and 11A, the system 11 can include a heat transfer system 54, which in one case includes or takes the form of one or more heat transfer channels 56 formed in the body 12 of each container 10 (three channels 56, including a channel 56 and two supplemental channels 56 in the illustrated embodiment). The heat transfer channels 56 are, in the illustrated embodiment, formed in/embedded in the bottom wall 24 of the container 10 and are oriented parallel to the longitudinal direction/axis and/or parallel to the heating element 14 in one case. In the illustrated embodiment, the bottom wall 24 has a greater thickness than the side walls 16, 18, end walls 20, 22, lid 26 and heating element 14, to accommodate the channels 56. However the heat transfer channels 56 could instead, or in addition, be formed in the side walls 16, 18, heating element 14 and/or lid 26 of the containers 10 and have a different orientation from that shown. Moreover in some cases no heat transfer channels (and/or no cavities or channels at all) are located in the side walls 16, 18 and/or lid 26 and/or heating element 14 of the containers 10.

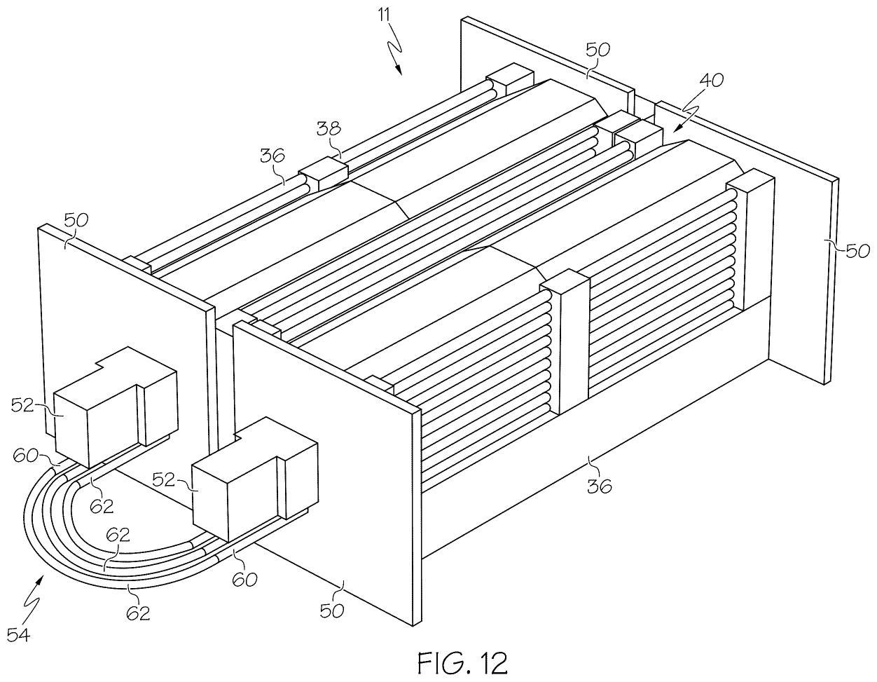

The channels 56 of one container 10 can be fluidly coupled to the channels 56 of another container 10. With reference to FIGS. 1 and 2, in one case the system 11/container includes openings 58 formed in the end walls 20, 22, and connecting pipes 60 extend through the openings 58 to fluidly connect the channels 56 of adjacent containers 10 (via conduit 62/exit flow paths 62 as shown in FIG. 12). Thus the channels 56 of each container 10 in a container column 32 can be fluidly coupled, and each channel 56 can be fluidly isolated from the associated cavity 28. Each individual channel 56 (or at least those portions of the channels 56 inside the associated container 10/body 12) can be fluidly isolated relative to the other channels 56 of that container 10/body 12.

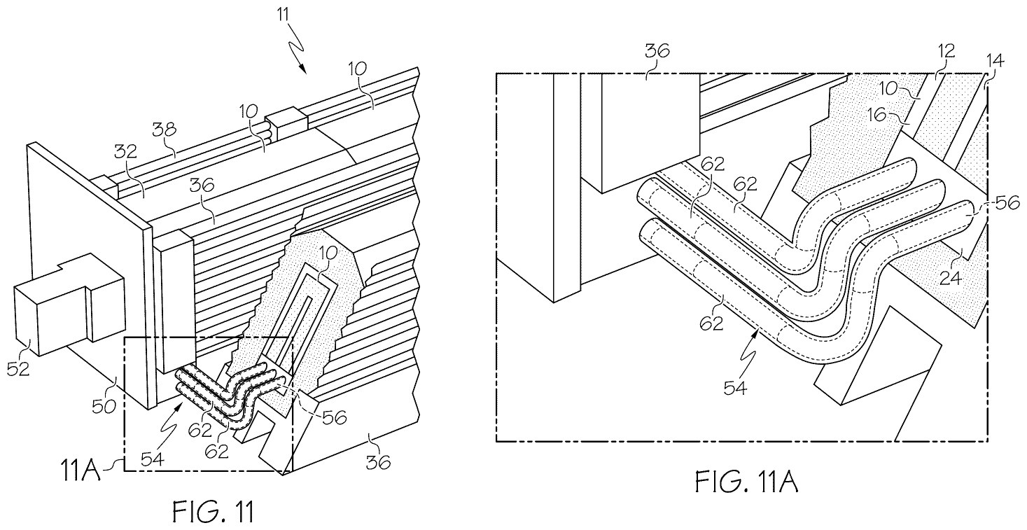

With reference to FIGS. 11, 11A and 12, the channels 56 of an end container 10/ container column 32 can be fluidly coupled to an exit fluid path 62, in the form of fluid conduit(s) in one case, such that fluid positioned in the channels 56 can exit the containers 10/system 11. The exit fluid path 62/conduit can fluidly connect the heat transfer system 54/channels 56 of one system 11/container column 32 to the heat transfer system 54/channels 56 of another system 11/container column 32. In this case the two containers 10 are arranged side by side, but are not in electrical communication, and their cavities 28 are fluidly isolated from each other.

The channels 56 can receive a thermally conductive fluid therein, such as nitrogen, helium or other inert gases. During the graphitization process, the fluid can absorb heat during the heating process. After heating of the payload material 44 is complete, the fluid can then be transported to another system 11/container column 32 (e.g. under positive and/or negative pressure in one case, and/or gravity feed in another case) to thereby transport the captured heat away from the first (heated) system 11/container column 32, to a second (in one case unheated, or less heated) system 11/container column 32. The heat transfer system 54/channels 56 can thus enable the first (heated) system 11/container column 32 to cool down faster. The heat transfer can also enable the second (unheated, or less heated) system 11/container column 32 to heat up faster, which can reduce processing time and save energy, particularly since the cooling step can be the longest step in the graphitization process.

The increased efficiency of the cooling of the containers 10/system 11 can also enable the use of more thermally insulative packing material 42. In particular, in prior systems, the packing material 42 may be desired to be thermally insulative to trap heat of the container 10. However if the packing material 42 was too thermally insulative, the system 11 could take too long too cool. By using the heat transfer system 54/channels 56 to cool the system 11, the system 11 can cool more quickly and the packing material 42 can be made of a more thermally insulative material/arrangement, leading to increased efficiency.

Rather than merely collecting and exporting heat, the heat transfer system 54/channels 56 can also receive therein imported (heated) fluid from another system 11, and/or from a thermal battery system. The importation of heated fluid can thereby warm up the containers 10/system 11, prior to and/or during graphitization, which reduces processing time and saves energy. In addition, the exported warmed fluid can be stored in a thermally insulative tank, or transfer its heat to other thermally insulative components such that the heat can be stored in a thermal battery. The stored heat can then be used to preheat another system 11, or for other processes or purposes where heat is needed.

It is noted that the channels 56 can be directly formed in the body 12 of the container 10 (e.g. in the bottom wall 24 in one case) such that the outer walls of the channels 56 are defined by the same materials of the body 12. In other words, the containers 10/system 11 can lack any piping positioned in or defining all, or at least part of, or a majority, or at least 90%, of a length of the channel 56, such that the wetted walls of the channel 56 are primarily (or in another case 90% of the length) defined by the, in one case, the graphite/carbonaceous material of the body 12. Forming the channels 56 in this manner reduces or eliminates the use of separate pipes/conduit, which provides a material savings, improves ease of manufacture, and reduces issues that may arise due to pipe/conduit breakage. In addition, the elimination or reduction of pipes/conduits enables the fluid to be in direct fluid contact with the container 10, which increases heat transfer between the fluid and the container 10.

It is also noted that the channels 56 are directly formed in the container 10, which essentially constitutes or operates as a heating element. This is in contrast with the use of piping or the like formed in the cradle 36 or refractory material, and/or the use of piping in the packing material 42, to provide heat transfer. Instead, channels 56 as disclosed herein are positioned in the container 10, and the container 10 itself is a heating element. The container 10 can thereby convey its heat directly to/from the fluid in the channels 56, which leads to more efficient heat transfer. This, in turn, heats/cools the fluid faster and leads to quicker and more efficient heating of the container 10 (during preheating of the system 11), and quicker and more efficient heating of the fluid (during cooldown of the system 11). Thus the container 10 can operate both as a heating element and a fluid containment device for the heat transfer fluid.

Having described the invention in detail and by reference to certain embodiments thereof, it will be apparent that modifications and variations are possible without departing from the scope of the invention which is defined in the appended claims.

1. A system for graphitization of carbon powder, the system including a graphitization container comprising:
a body made of a carbonaceous material, the body having a cavity extending in a longitudinal direction, the body further having an opening in communication with the cavity;
a heating element made of a carbonaceous material, wherein the heating element is positioned in the cavity such that the heating element extends in the longitudinal direction; and
a lid configured to removably cover the opening, wherein the system is configured such that when the lid is removed, the opening provides access to the cavity in a direction perpendicular to the longitudinal direction for at least one of loading or unloading of a payload material into or out of the cavity.

2. The system of claim 1 wherein the body, the heating element, and the lid are each made of a carbonaceous material and a binder.

3. (canceled)

4. The system of claim 1 wherein the heating element extends an entire length of the cavity in the longitudinal direction, and wherein the opening extends at least about 80% of a length of the cavity the longitudinal direction.

5. The system of claim 1 wherein the opening is located at an upper end of the body with regard to a gravitational frame of reference.

6. The system of claim 1 wherein the system is configured for longitudinal graphitization of graphite powder, wherein the body, the heating element and the lid each have an electrical resistivity of between about 2 micro-Ohm*meter and about 20 micro-Ohm*meter, and wherein the body, the heating element and the lid are each configured to withstand temperatures of at least about 2000 degrees Celsius, and wherein the body and the heating element are both able to accommodate electrical currents densities in excess of 20 A/cm.

7. (canceled)

8. The system of claim 1 wherein the body is shaped as a rectangular prism having a pair of spaced-apart side walls, a pair of spaced-apart end walls and a bottom wall, and wherein the lid is configured to be positioned parallel to the bottom wall when the lid removably covers the opening.

9. The system of claim 8 wherein the heating element is oriented parallel with and equally spaced from the pair of side walls, wherein the heating element is in direct physical and electrical contact with the pair of end walls and with the bottom wall, and wherein the heating element does not extend axially beyond the body.

10. (canceled)

11. The system of claim 1 wherein the lid is configured to be in direct physical and electrical contact with the heating element when the lid removably covers the opening.

12. The system of claim 1 further including a containment device receiving the body therein, and wherein the body is at least partially covered by thermally insulative packing material positioned between the body and the containment device.

13. The system of claim 12 wherein the body is covered on all sides by the packing material.

14. The system of claim 12 wherein the body is filled with at least one of loose or powdered amorphous carbon payload material.

15. The system of claim 12 further including a supplemental body positioned in the containment device, wherein the supplemental body is in electrical communication with the body.

16. The system of claim 15 wherein the body includes a channel formed therein and fluidly isolated from the cavity of the body, wherein the supplemental body includes a channel formed therein and fluidly isolated from the cavity of the supplemental body, and wherein the channel of the body and the channel of the supplemental body are each configured to receive fluid therein and be in fluid communication with each other such that fluid in both channels can conduct heat at least one of to, or away from, the associated body.

17. The system of claim 12 wherein the containment device is made of at least one of refractory, metal or other inorganic material.

18. The system of claim 1 wherein the body includes a channel formed therein and fluidly isolated from the cavity, where the channel is configured to receive fluid therein such that fluid in the channel can conduct heat at least one of to, or away from, the body.

19. The system of claim 18 wherein the channel is formed directly in the body of the container such that the walls of the channel are defined by the materials of the body.

20-22. (canceled)

23. A system for graphitization of carbon powder, the system including a graphitization container comprising:
a body made of a carbonaceous material, the body having a cavity extending in a longitudinal direction, the body further having an opening in communication with the cavity;
a heating element made of a carbonaceous material, wherein the heating element is positionable in the cavity such that the heating element extends in the longitudinal direction; and
a lid configured to removably cover the opening, wherein the lid is not configured to be directly threadably coupled to the body, wherein the system is configured such that when the lid is removed, the opening provides access to the cavity for at least one of loading or unloading of a payload material into or out of the cavity.

24. The system of claim 23 wherein the system is configured such that when the lid is removed, the opening provides access to the cavity in a direction perpendicular to the longitudinal direction for at least one of loading or unloading of a payload material into or out of the cavity.

25. (canceled)

26. (canceled)

27. A method comprising:
accessing a container including a body made of a carbonaceous material and having an inner cavity, the container including a heating element made of a carbonaceous material positioned in the inner cavity, the body having an opening extending in a longitudinal direction and in communication with the cavity;
loading loose or powdered amorphous carbon payload material into the cavity via the opening; and
passing electrical current through the body and the heating element for a predetermined time to heat the body, the heating element and the payload material to cause graphitization of the payload material.

28. The method of claim 27 wherein, during the passing step, the heating element, the body and the payload material together provide at least 90% of Joule heating of the container, and wherein the loading step includes loading loose or powdered amorphous carbon payload material into the cavity via the opening in a direction generally perpendicular to the longitudinal direction.

29. A method comprising:
accessing a container including a body made of a carbonaceous material and having an inner cavity, the container including a heating element made of a carbonaceous material positioned in the inner cavity, the body having an opening;
loading loose or powdered amorphous carbon payload material into the cavity via the opening;
covering with opening with a lid, wherein the lid is not directly threadably coupled to the body; and
passing electrical current through the body and the heating element for a predetermined time to heat the body, the heating element and the payload material to cause graphitization of the payload material.

30. A method comprising:
accessing a container including a body made of a carbonaceous material and having an inner cavity, and wherein the container is positioned in a containment device;
loading at least one of loose or powdered amorphous carbon payload material into the cavity while the body remains positioned in the containment device; and
after the loading step, passing electrical current through the body for a predetermined time to heat the body and the payload material to cause graphitization of the payload material.

31. The method of claim 30 wherein the containment device includes or is made of refractory, metal or other inorganic material, and wherein the body is at least partially covered by a thermally insulative packing material positioned between the body and the containment device.

32. The method of claim 30 wherein the container includes a heating element positioned in the cavity and made of a carbonaceous material, wherein the passing step includes passing current through the heating element, wherein the body includes an opening extending in a direction of greatest length of the cavity and in communication with the cavity, and wherein the body includes a lid configured to removably cover the opening, wherein the method further includes removing the lid to provide access to the cavity for at least one of loading or unloading of the payload material into or out of the cavity.

33-44. (canceled)
